(19) United States
(12) Patent Application Publication
(10) Pub. No.: US 2003/0227912 A1
(43) Pub. Date: Dec. 11, 2003

(54) Voice packet preferential control equipment and control method thereof

(75) Inventor: Seiji Kachi, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/449,234

(22) Filed: Jun. 2, 2003

(30) Foreign Application Priority Data
Jun. 5, 2002 (JP) 2002-164113

(51) Int. Cl. H04L 12/66

(52) U.S. Cl. 370/352; 370/235; 370/328; 370/338

(57) ABSTRACT

The present invention enables voice packet communication in a wireless LAN utilizing inexpensive LAN equipment not supporting QoS, such as preferential control, band control and so forth, and can realize preferential control of voice packet without modifying an existing wireless LAN access point not supporting QoS. In a case where voice packets are admixed in packet communication via the wireless LAN, when a round trip period becomes large, a voice packet preferential control equipment gives preference for voice packet transmission with interrupting data packet transmission to a wireless LAN access point in a valve in order to prevent deterioration of communication quality of the voice packet.

### CROSS REFERENCE TO THE RELATED APPLICATION

The present application has been filed with claiming priority based on Japanese Patent Application No. 2002-164113, filed on Jun. 5, 2002. Disclosure of the above-identified Japanese Patent Application is herein incorporated by reference.

### BACKGROUND OF THE INVENTION

1. Field of the Invention

The present invention relates generally to a preference control in a voice packet control. More particularly, the invention relates to a voice packet preference control equipment and control method thereof to be added in the conventional transmission path, such as wireless LAN and so forth.

2. Description of the Related Art

In the recent years, it has been developed VoIP (Voice over IP) technology using IP (Internet Protocol) which is originally a standard protocol of data communication, and transmits voice by IP packet, and has been put into practice.

An application enabling telephone call from a personal computer, a telephone machine or so forth via Internet or LAN (Local Area Network), is an IP telephone. Such IP telephone is attracting attention as a method for establishing a telephone network at low cost.

However, since LAN has been grown for data communication by computers in history, it employs a simple control equipment as “data arriving earlier is processed earlier”. Therefore, upon transmitting voice packet on LAN, it becomes necessary to preferentially process voice packet relative to data packet so as not to cause delay in transmission of voice packet.

On the other hand, hot spot service using wireless LAN has been provided. In such service, in addition to demand for data communication, there is not small demand for voice communication using the foregoing VoIP technology. A problem arisen at this time is how to realize QoS (Quality of Service), such as preferential control or band control.

Namely, in the voice packet communication employing the wireless LAN, since transmission speed of a wired LAN is 100 Mbps to 1 Gbps whereas transmission speed of the wireless LAN is about 10 Mbps, retention of packet in a conversion device (access point of wireless LAN) for conversion from the wired LAN to the wireless LAN is inherently caused. For this reason, it becomes necessary to provide a buffer for voice packet and a buffer for data packet separately in the wireless LAN access point and to ensure real-time transmission ability of voice packet by processing voice packet preferentially.

As set forth above, in the voice packet communication using the wireless LAN, inexpensive LAN devices currently marketed do not support QoS, such as preferential control, band control and so forth.

### SUMMARY OF THE INVENTION

The present invention has been worked out in view of the drawback in the conventional wireless LAN devices. It is therefore an object of the present invention to provide a wireless LAN system which enables voice packet communication in a wireless LAN utilizing inexpensive LAN equipment not supporting QoS, such as preferential control, band control and so forth, and can realize preferential control of voice packet without modifying an existing wireless LAN access point not supporting QoS.

In order to accomplish the above-mentioned object, according to the first aspect of the present invention, a voice packet preferential control equipment added a media conversion equipment connecting a high speed communication circuit and a low speed communication circuit,

when a voice packet is detected from packet information on a communication circuit, the control equipment preferentially transmits a voice packet and interrupting transmission of data packet from the high speed circuit and buffering data packet,

subsequently, the control equipment. checks traffic of the low speed circuit, continues the buffering when the traffic is in congestion state and terminates buffering to resume data packet transmission when the traffic is in non-congestion state.

In the preferred construction of the voice packet preferential control equipment, a wireless LAN access point as the media conversion equipment, connects a high speed wired LAN circuit as high speed communication circuit and a low speed wireless LAN circuit as low speed communication circuit. In practical operation, when a voice packet is detected from packet information on a communication circuit, the control equipment preferentially transmits a voice packet and interrupts transmission of data packet from the high speed wired LAN circuit and buffering data packet, and subsequently, the control equipment checks traffic of the low speed wireless LAN circuit, continues the buffering when the traffic is in congestion state and terminates buffering to resume data packet transmission when the traffic becomes non-congestion state.

The control equipment may include means for checking traffic in the low speed circuit, the means feeding a ping packet to a voice packet terminal of the low speed circuit, receiving a ping response from the voice packet terminal, and making judgment of traffic condition by measuring a round trip period between feeding of the ping packet and reception of the ping response.

The means for checking traffic may make judgment that traffic is in congestion state when the round trip period is larger than or equal to a preset value and that traffic is not in congestion state when the round trip period is smaller than the preset value.

According to the second aspect of the present invention, a voice packet preferential control method added medium conversion equipment connecting a high speed communication circuit and a low speed communication circuit,

when a voice packet is detected from packet information on a communication circuit, a voice packet is preferentially transmitted and transmission data packet from the high speed circuit being interrupted and data packet is buffered,

subsequently, traffic of the low speed circuit is checked, buffering is continued when the traffic is in congestion state and buffering is terminated to resume data packet transmission when the traffic becomes non-congestion state.

According to the third aspect of the present invention, a voice packet preferential control equipment adding a wireless LAN access point connecting a high speed wired LAN circuit and a low speed wireless LAN circuit, comprises:

voice packet detecting and separating block separating packets received from a VoIP terminal on a wired LAN side into voice packets and data packets;

data packet buffer buffering data packet separated by the voice packet detecting and separating block;

ping generating block generating a ping packet for measuring traffic condition of the wireless LAN;

ping measuring block measuring a period from transmission of the ping packet from the ping generating block to reception of a response to the ping packet;

a valve determining whether data in data buffer is to be transmitted to the wireless LAN side; and

voice packet detection block detecting the voice packets from packets received from the wireless LAN access point.

The voice packet detecting and separating block may transmit the separated voice packet to the wireless LAN access point.

The valve may interrupt transmission of data packet to the wireless LAN side when the period from transmission of the ping packet from the ping generating block to reception of a response to the ping packet is longer in comparison with a period in good condition of the circuit.

The voice packet preferential control equipment may further comprise an ftp terminal transmitting and receiving data packet on the wired LAN side and the wireless LAN side, and similar process as that for data packet transmitted from VoIP terminal, is performed for data packet transmitted from the ftp terminal.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a block diagram showing overall construction of a voice packet communication system according to the present invention;

FIG. 2 is a basic sequence chart showing a relationship of voice packet transmission and reception and ping packet transmission and reception for measuring circuit congestion condition on a wireless LAN;

FIG. 3 is a sequence chart in the case where communication between ftp terminals transmitting and receiving data packet and communication between VoIP terminal transmitting and receiving voice packet are performed simultaneously; and

FIG. 4 is a process flowchart relating to buffering start (data packet transmission interruption) in voice packet preferential control equipment 104 and buffering termination (data packet transmission resumption).

### DESCRIPTION OF THE PREFERRED EMBODIMENT

The present invention will be discussed hereinafter in detail in terms of the preferred embodiment of a wireless LAN system according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscurity of the present invention.

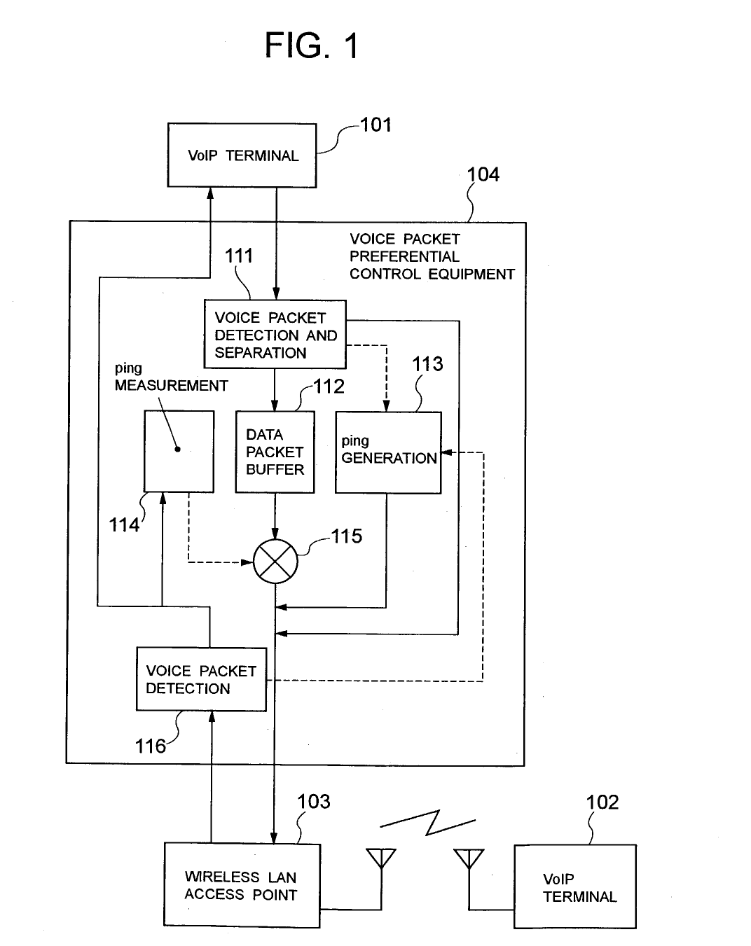

FIG. 1 is a block diagram showing an overall construction of a wireless LAN system with a voice packet preferential control equipment in accordance with the present invention. As shown in FIG. 1, VoIP (Voice over IP) terminal 101 is connected to a wired LAN side interface of a voice packet preferential control equipment 104 via a wired LAN. A wireless LAN side interface of the voice packet preferential control equipment 104 is connected to a wireless LAN access point 103. A VoIP terminal 102 is connected to the wireless LAN access point 103 via a wireless medium in communicatable condition. The voice packet preferential control equipment 104 is inserted between the wired LAN side VoIP terminal 101 and the wireless LAN access point 103.

The voice packet preferential control equipment 104 is constructed with a voice packet detection and separation block 111 separating packets received from the VoIP terminal on the wired LAN side into voice packets and data packets, a data packet buffer 112 buffering data packet separated by the voice packet detection block 111, a ping generation block 113 generating aping packet for measurement for measuring traffic of the circuit on the wireless LAN, a ping measurement block 114 for measuring a period up to reception of a response to a ping packet transmitted by the pin generation block 113, a valve 115 determining whether data of the data packet buffer 112 is to be transmitted to the wireless LAN side, and a voice packet detection block 116 detecting a voice packet from the packet received from the wireless LAN access point 103.

It should be noted that the foregoing ping packet is a command to be used for verifying connection ability between terminals on an IP network including the wired LAN or the wireless LAN and checks how crowed of traffic in a route to a counterpart by measuring the period up to reception of the response.

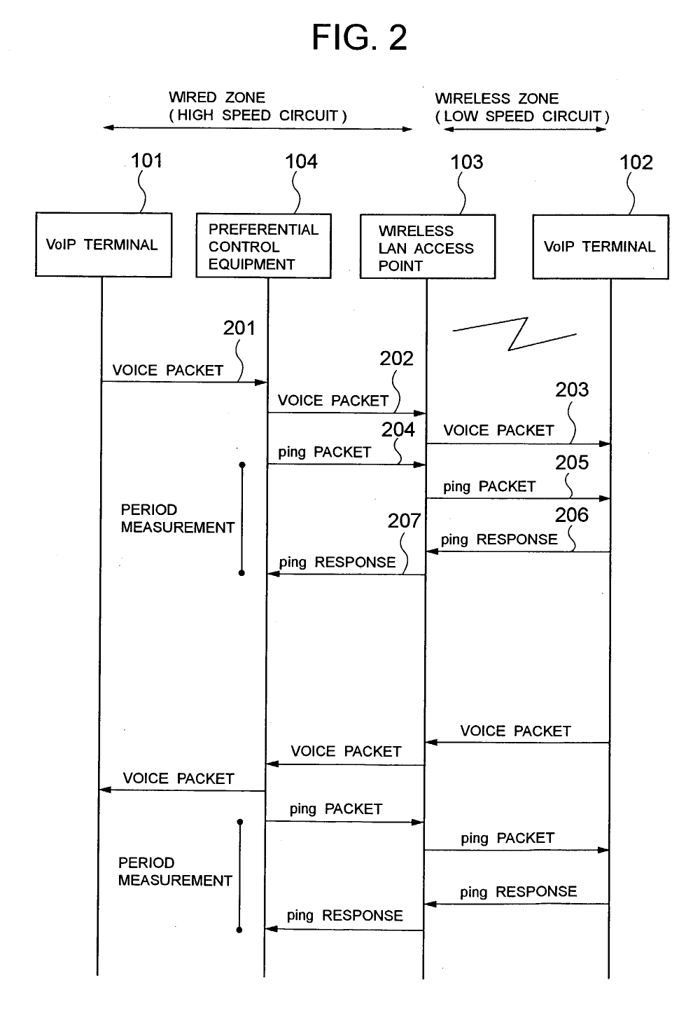

FIG. 2 is a basic sequence chart showing a relationship of voice packet transmission and reception and ping packet transmission and reception for measuring circuit congestion condition on a wireless LAN. As shown in FIGS. 1 and 2, when the voice packet preferential control equipment 104 receives a voice packet 201 from the VoIP terminal lol on wired LAN side, a voice packet 202 is separated by the voice packet detection and separation block 111 and transmitted to the wireless LAN access point 103. In conjunction therewith, in the ping generation block 113, ping packet 204 is generated and transmitted to the wireless LAN access point 103.

The wireless LAN access point 103 delivers a voice packet 203 to the VoIP terminal 102. In conjunction therewith, the ping packet 205 is also transmitted. Upon reception of the ping packet 205, the VoIP terminal 102 generates a ping response 206 as response packet and feeds the same to the wireless LAN access point 103. The wireless LAN access point 103 feeds a ping response 207 to the voice packet preferential control equipment 104.

As a result, the voice packet preferential control equipment 104 measures the period up to reception of the ping response 207 from transmission of the ping packet 204 by the ping measurement block 114 to know a round trip period between the voice packet preferential control equipment 104 and the VoIP terminal 102. This round trip period is a transmission period transmitted and returned through a high speed wired circuit between the voice packet preferential control equipment 104 and the wireless LAN access point 103 and a low speed wireless circuit between the wireless LAN access point 103 and the VoIP terminal 102. Most of the round trip period is occupied by the transmission period in the low speed wireless LAN zone.

On the other hand, since the wireless LAN access point 103 performs conversion between the high speed wired LAN and the low speed wireless LAN, delay according to increase of the packet received from the wired LAN becomes greater. When traffic in the circuit of the wireless LAN increases (congestion condition), round trip period between the voice packet preferential control equipment 104 and the VoIP terminal 102 prolongs.

Accordingly, in the case where the voice packet is mixed in packet communication via the wireless LAN, when round trip period becomes large, the voice packet preferential control equipment 104 performs preferential control in which transmission of data packet to the wireless LAN access point 103 is interrupted at the valve 115 and the voice packet is preferentially transmitted in order to prevent deterioration of communication quality of the voice packet. While transmission of data packet is interrupted, data packet is buffered by the data packet buffer 112.

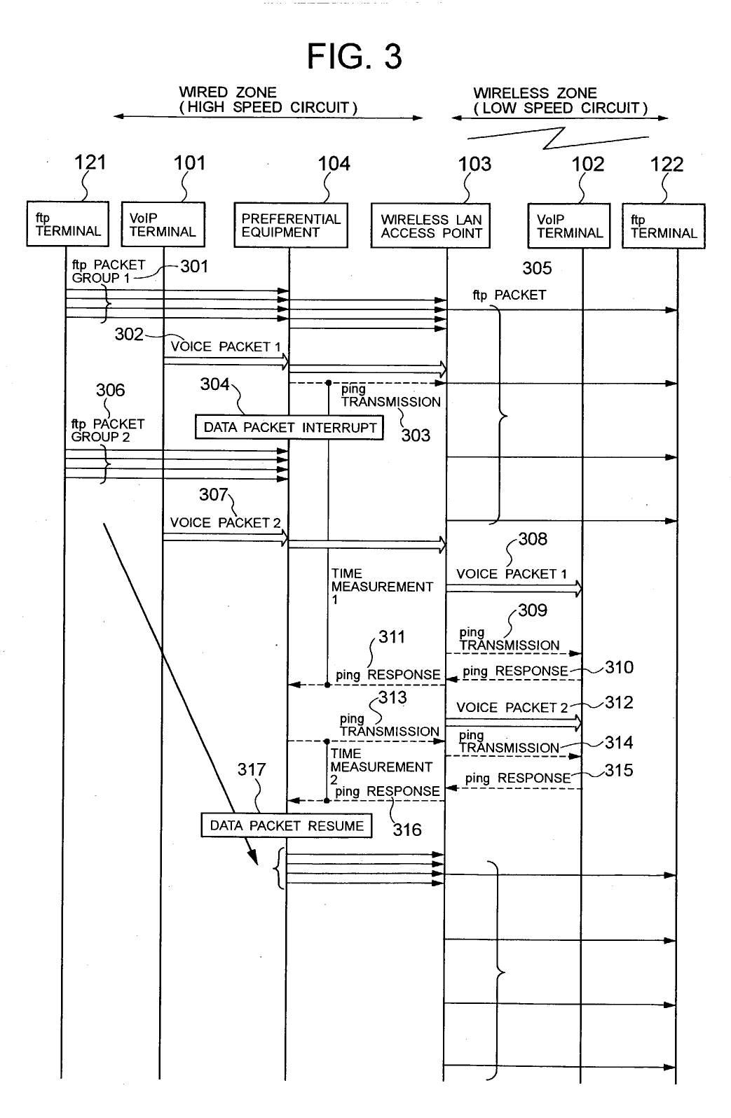

FIG. 3 is a sequence chart in the case where communication between ftp terminals transmitting and receiving data packet and communication between VoIP terminal transmitting and receiving voice packet are performed simultaneously. Here, the ftp terminal is a terminal implementing FTP (File Transfer Protocol) as standard protocol for file transfer on Internet. The ftp terminal is normal data terminal, such as personal computer or the like, and can perform data transfer by executing an FTP application. It should be noted that detail of FTP is defined by RFC (Request For Comment) 959.

As shown in FIG. 3, the ftp terminal 121 and the VoIP terminal 101 are connected to the voice packet preferential control equipment 103 via the wired circuit in communicatable condition. The ftp terminal 122 and the VoIP terminal 102 are connected to the wireless LAN access point 103 via the wireless circuit in communicatable condition. On the other hand, the voice packet preferential control equipment 104 performs detection and preferential control of data packet and voice packet. The wireless LAN access point 103 transmits the packet received from the wired LAN side to the wireless LAN side, and transmits the packet received from the wireless LAN side to the wired LAN side, in sequential order.

At first, when 100 Kbytes data is transmitted from the ftp terminal 121 on the wired LAN side to the ftp terminal 122 on the wireless LAN side, the ftp terminal 121 transmits sixty-seven ftp packets 301 (ftp packet group 1) to the voice packet preferential control equipment 104, since 100 Kbytes data are transmitted per about 1500 bytes in IP communication. In the voice packet preferential control equipment 104, since the voice packet is not transmitted and received at this time, the ftp packet 301 is transmitted to the wireless LAN access point 103 as is. Since the wireless zone is lower speed than the wired zone, the wireless LAN access point 103 transmits a ftp packet 305 to the ftp terminal 122 with longer period.

Next, it is assumed that while the wireless LAN access point 103 transmits the ftp packet 305, the VoIP terminal 101 transmits the voice packet 1 (302). Then, the voice packet preferential control equipment 104 feeds the voice packet to the wireless LAN access point 103 and in conjunction therewith transmits the ping packet 303 to the VoIP terminal 102. On the other hand, the voice packet preferential control equipment 104 interrupts transmission of data packet until congestion condition of the wireless circuit is known by the ping response and buffers data packet (step 304).

In the wireless LAN access point 103, the voice packet 1 (302) and the ping packet 303 are received. However, since transmission of ftp packet 305 is not yet completed, the received voice packet and the pin packet are placed in waiting state until wireless circuit becomes vacant. After completion of transmission of the ftp packet 305, the wireless LAN access point 103 transmits the voice packet (308) and the ping packet 309 to the VoIP terminal 102.

Next, the voice packet preferential control equipment 104 receives new ftp packet 306 (ftp packet group 2) from the ftp terminal 121 and new voice packet 2 (307) from the VoIP terminal 101. However, since transmission of data packet is already interrupted, the ftp packet 306 is buffered in the data packet buffer 112 of the voice packet preferential control equipment 104 and the voice packet preferential control equipment 104 feeds only voice packet 2 (307) to the wireless LAN access point 103.

Subsequently, the voice packet preferential control equipment 104 receives the ping response 311 to the first ping packet and measures a period. However, since the ping packet 305 is transmitted by the wireless LAN access point 103, the round trip period becomes larger in comparison with the condition where the circuit condition is good. Therefore, at this timing, interruption of transmission of data packet is not terminated, and the ping packet 313 is transmitted again to perform period measurement 2.

At the timing where the ping packet 313 is transmitted, condition of the wireless circuit is resumed from congestion condition. Therefore, the wireless LAN access point 103 immediately feeds the ping packet 314 to the VoIP terminal 102. Also, the VoIP terminal 102 immediately responds to the ping packet 314 to feed the ping response 315. The ping response 316 reaches the voice packet preferential control equipment 104 via the wireless LAN access point 103.

As a result, the round trip period in time measurement 2 becomes small to permit recognition that the congestion condition in the wireless circuit is resolved, in the voice packet preferential control equipment 104. The voice packet preferential control equipment 104 recognizing that the congestion condition is resolved, resumes transmission of the ftp packet 306 (ftp packet group 2) as buffered (step 317).

As set forth above, the voice packet preferential control equipment 104 realizes preferential control of the voice packet in order to prevent deterioration of communication quality of the voice packet in the case where the voice packet is mixed in packet communication via the wireless LAN.

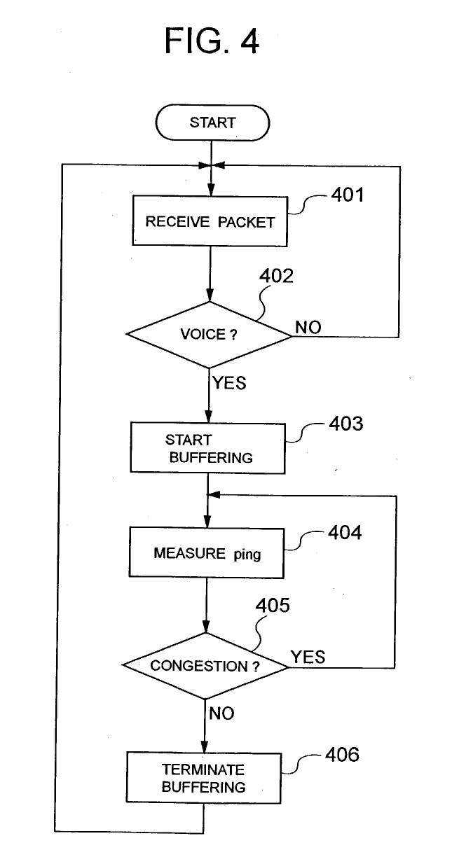

FIG. 4 is a process flowchart relating to buffering start (data packet transmission interruption) in voice packet preferential control equipment 104 and buffering termination (data packet transmission resumption). In the voice packet preferential control equipment 104, packet information containing data packet and voice packet in admixing manner is received from the wired LAN side (step 401). Then, judgment is made whether the received packet is voice packet or not (step 402). When the received packet is the voice packet, the voice packet is preferentially fed to the wireless LAN side, and buffering of the subsequently transmitted data packet is started (step 403). Thereafter, the pin packet is generated and fed to the counterpart VoIP terminal, and then the ping response is received for ping measurement in order to measure the round trip period (step 404). As a result of measurement, when the round period is large and congestion is judged, the ping measurement is performed again. On the other hand, when judgment is made that the traffic is not in congestion, buffering is terminated (step 406).

It should be appreciated that while the particular numerical relationship between actual period up to reception of the ping response and data packet transmission interruption/resumption judgment is not recited in the shown embodiment, in consideration that the typical allowable delay period is about 200 ms (voice delay upon use of satellite circuit), interruption/resumption of buffering of data packet may be performed with taking 200 ms as criterion. However, the particular value, i.e. 200 ms should not be taken as limitative to the present invention. In practice, the practical criterion may be determined utilizing actually measured data as being influenced by buffer capacity of the wireless LAN access point, speed difference between the wireless circuit and the wired circuit.

On the other hand, while the shown embodiment has been discussed in terms of the network system employing the wireless LAN, the voice packet preferential control equipment utilizing the VoIP technology is applicable not only for wireless LAN but also for media converting equipment (e.g. ADSL modem) having communication speed difference. The present invention is further applicable in general for speed conversion equipment connecting the high speed circuit and the low speed circuit.

Namely, in place of the wireless LAN access point in FIG. 1, an ADSL modem is arranged. The VoIP terminal 101, the voice packet preferential control equipment 104 and the ADSL modem are connected. The ADSL modem is connected to the VoIP terminal 102 via a metallic circuit provided transmission speed limit. Thus, the voice packet preferential transmission control in packet communication where voice packet is mixed, can be realized between the VoIP terminal 101 and the VoIP terminal 102.

As set forth above, the present invention is effective in providing voice packet communication in the wireless LAN utilizing inexpensive LAN equipment not supporting QoS, such as preferential control, band control or so forth.

Also, since the voice packet preferential control is realized utilizing pin packet as general purpose command, the present invention is advantageous in that the voice packet preferential control will not be influenced by variation of system of wireless LAN in the future.

Furthermore, the present invention is advantageously applicable not only for the wireless LAN but also for media converting equipments (for example, ADSL modem having speed difference).

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A voice packet preferential control equipment added a media conversion equipment connecting a high speed communication circuit and a low speed communication circuit,
when a voice packet is detected from packet information on a communication circuit, said control equipment preferentially transmitting a voice packet and interrupting transmission of data packet from said high speed circuit and buffering data packet,
subsequently, said control equipment checking traffic of said low speed circuit, continuing said buffering when the traffic is in congestion state and terminating buffering to resume data packet transmission when the traffic is in non-congestion state.

2. A voice packet preferential control equipment added a wireless LAN access point connecting a high speed wired LAN circuit and a low speed wireless LAN circuit,
when a voice packet is detected from packet information on a communication circuit, said control equipment preferentially transmitting a voice packet and interrupting transmission of data packet from said high speed wired LAN circuit and buffering data packet,
subsequently, said control equipment checking traffic of said low speed wireless LAN circuit, continuing said buffering when the traffic is in congestion state and terminating buffering to resume data packet transmission when the traffic becomes non-congestion state.

3. A voice packet preferential control equipment as set forth in claim 1, wherein said control equipment includes means for checking traffic in said low speed circuit, said means feeding a ping packet to a voice packet terminal of said low speed circuit, receiving a ping response from said voice packet terminal, and making judgment of traffic condition by measuring a round trip period between feeding of the ping packet and reception of the ping response.

4. A voice packet preferential control equipment as set forth in claim 3, wherein said means for checking traffic makes judgment that traffic is in congestion state when said round trip period is larger than or equal to a preset value and that traffic is not in congestion state when said round trip period is smaller than said preset value.

5. A voice packet preferential control method added a media conversion equipment connecting a high speed communication circuit and a low speed communication circuit,
when a voice packet is detected from packet information on a communication circuit, a voice packet being preferentially transmitted and transmission data packet from said high speed circuit being interrupted and data packet being buffered,
subsequently, checking traffic of said low speed circuit, buffering being continued when the traffic is in congestion state and buffering being terminated to resume data packet transmission when the traffic becomes non-congestion state.

6. A voice packet preferential control method added a wireless LAN access point connecting a high speed wired LAN circuit and a low speed wireless LAN circuit,
when a voice packet is detected from packet information on a communication circuit, a voice packet being preferentially transmitted and transmission data packet from said high speed wired LAN circuit being interrupted and data packet being buffered,
subsequently, checking traffic of said low speed wireless LAN circuit, buffering being continued when the traffic is in congestion state and buffering being terminated to resume data packet transmission when the traffic becomes non-congestion state.

7. A voice packet preferential control method as set forth in claim 5, which includes a step of checking traffic in said low speed circuit, wherein a ping packet is fed to a voice packet terminal of said low speed circuit, a ping response from said voice packet terminal is received, and judgment of traffic condition is made by measuring a round trip period between feeding of the ping packet and reception of the ping response.

8. A voice packet preferential control method as set forth in claim 7, wherein in said step of checking traffic judgment is made that traffic is in congestion state when said round trip period is larger than or equal to a preset value and that traffic is not in congestion state when said round trip period is smaller than said preset value.

9. A voice packet preferential control equipment adding a wireless LAN access point connecting a high speed wired LAN circuit and a low speed wireless LAN circuit, comprising:
voice packet detecting and separating block separating packets received from a VoIP terminal on a wired LAN side into voice packets and data packets;
data packet buffer buffering data packet separated by said voice packet detecting and separating block;
ping generating block generating a ping packet for measuring traffic condition of the wireless LAN;
ping measuring block measuring a period from transmission of said ping packet from said ping generating block to reception of a response to said ping packet;
a valve determining whether data in data buffer is to be transmitted to said wireless LAN side; and
voice packet detection block detecting the voice packets from packets received from said wireless LAN access point.

10. A voice packet preferential control equipment as set forth in claim 9, wherein said voice packet detecting and separating block transmits the separated voice packet to said wireless LAN access point.

11. A voice packet preferential control equipment as set forth in claim 9, wherein said valve interrupts transmission of data packet to the wireless LAN side when the period from transmission of said ping packet from said ping generating block to reception of a response to said ping packet is longer in comparison with a period in good condition of the circuit.

12. A voice packet preferential control equipment as set forth in claim 9, which further comprises an ftp terminal transmitting and receiving data packet on said wired LAN side and said wireless LAN side, and similar process as that for data packet transmitted from VoIP terminal, is performed for data packet transmitted from said ftp terminal.
